(19) United States
(12) Patent Application Publication
(10) Pub. No.: US 2023/0206320 A1
(43) Pub. Date: Jun. 29, 2023

(54) METHOD AND SYSTEM FOR GENERATING A FINANCIAL INFOGRAPHIC OF A USER THROUGH A FINANCING PLATFORM

(71) Applicant: MAGNISAVE GROUP SDN. BHD., Kuala Lumpur (MY)

(72) Inventor: Vincent SOH AIK GUAN, Kuala Lumpur (MY)

(73) Assignee: MAGNISAVE GROUP SDN. BHD., Kuala Lumpur (MY)

(21) Appl. No.: 17/565,256

(22) Filed: Dec. 29, 2021

(51) Int. Cl. G06Q 40/02

(52) U.S. Cl. CPC G06Q 40/025

(57) ABSTRACT

A method includes receiving a selection of at least one credit rating agency from a list of the credit rating agencies displayed on a graphical user interface of an applicant device, a credit score associated with the selected credit rating agency, and a financing status of the user; calculating a base financing rate for loan or investment; receiving a selection of risk metrics from the user and calculating, a risk reduction incentive rate based on the received selection of risk metrics; determining, a reduced financing rate by deducting the risk reduction incentive rate; and generating, the cost of financing to the user and the financial infographic associated with a loan of the user or investment to an investee where the loan and/or investment can be electronically funded by a plurality of lenders or investors and displaying the financial infographic to the user via the graphical user interface.

### TECHNICAL FIELD

The present invention relates generally to a financing platform as well as an investment platform. More particularly, the present invention relates a system and method for generating a cost of financing to a user (e.g., borrower or investee) and for generating a financial infographic of a user through a financing/investment platform.

### BACKGROUND OF THE INVENTION

Typically, a credit score is a score that depicts a creditworthiness of a borrower. Traditional credit scoring is mainly used by lenders to help them decide whether to extend or deny credit, and if credit is extended, the borrowers are only informed of financial charges, for example base lending rate+1.50% p.a. The credit scoring is a statistical analysis performed by the lenders and financial institutions to determine a person's or a small, owner-operated business' creditworthiness. The lenders use the credit scoring models usually to derive a credit score based on historical data. The credit score can impact many financial transactions, including mortgages, auto loans, credit cards, and private loans. There are several credit scoring models which are commercially available, these credit scoring models includes but is limited to, Fair, Isaac and Company (FICO), Vantage Score, and the like.

Although credit scoring ranks a borrower's credit riskiness, it does not provide an estimate of a borrower's default probability but merely assesses a borrower's riskiness from highest to lowest. As such, credit scoring suffers from its inability to determine whether one borrower is twice as risky as another borrower. Another interesting limit to the current credit scoring models is its inability to explicitly factor in current economic conditions. For example, if a borrower has a credit score of 800, but the economy has just started to enter into a recession, the borrower's credit score would not be adjusted unless the borrower behavior or financial position changed. In other words, the credit score models are based on historical data and they cannot reflect any changes in real time.

Therefore, a need exists for a peer-to-peer lending and/or financing system and/or investment system to incorporate a business and credit risk reduction incentive and scoring to solve the above-mentioned problems.

### SUMMARY OF THE INVENTION

Various embodiments of the present technology provide a method and system for generating a cost of financing to a user (e.g., borrower or investee) and for generating a financial infographic of the user through a financing/investment platform. The present technology generates a cost of financing by taking into account of various risk reduction incentives that is rewarded to the borrower or investee for taking certain actions to lower their credit and business risks,

In a first aspect of the invention, there is provided a processor-implemented method of generating a cost of financing to a user (e.g., borrower or investee) and generating of a financial infographic of the user through a financing/investment platform. The cost of financing is generated taking into account of various risk reduction incentives that is rewarded to the borrower or investee for taking certain actions to lower their credit and business risks. This invention takes into consideration the current economic conditions and reflects changes in real time and factors these to derive a cost of financing that is real-time, risk-based adjusted and fairer to both the borrower or Investee and the lender or investor. The method includes receiving a selection of at least one credit rating agency from a list of the credit rating agencies displayed on a graphical user interface of a user device, a credit score associated with the selected credit rating agency, and a financing status of the user, via the graphical user interface, from the user, by a credit risk agency module associated with the financing/investment platform. The method further includes calculating a base financing rate for loan or investment, by a financing rate module, based on at least one of: the credit score received from the user and financing status of the user. The method furthermore includes receiving a selection of risk metrics from the user via the graphical user interface and calculating, a risk reduction incentive rate based on the received selection of risk metrics by the risk reduction and incentive module. The method furthermore includes determining, by the financing rate module, a reduced financing rate by deducting the risk reduction incentive rate from the at least one of: the base financing rate or a predetermined base financing rate. The method furthermore includes generating, by an infographic module, the cost of financing to the user and the financial infographic associated with a loan of the user or investment to an investee on the financing/investment platform where the loan and/or investment can be electronically funded by a plurality of lenders or investors. The financial infographic comprises at least the financing status of the applicant and the reduced financing rate and displaying the financial infographic to the user via the graphical user interface.

In an embodiment, receiving a selection includes displaying a list of the credit rating agencies on the graphical user interface, by a credit risk agency module, prompting the user, by the credit risk agency module to select at least one credit rating agency from a list of credit rating agencies displayed to the user on the graphical user interface, and prompting the user, by the credit risk agency module, to provide the credit score based on the selected credit rating agency. The user is a one of: a borrower and an investee.

In an embodiment, receiving the selection of risk metrics from the user includes generating a list of risk metrics and displaying the list of risk metrics to the user on the graphical user interface by the risk reduction and incentive module, and prompting the user to select one or more risk metrics from the generated list of risk metrics.

In another aspect, there is provided a system for generating a cost of financing to a user and for generating a financial infographic of the user through a financing/investment platform. The system includes a financing/investment platform operated by a centralized cloud-based server. The financing/investment platform includes a memory that stores an information associated with financing/investment platform and one or more executable modules and a processor that executes the one or more executable modules using the information associated with the financing/investment platform. The one or more executable modules includes a financing rate module configured to receive a loan or investment application along with at least: a financing status and a credit score, of a user and perform at least one of: computing a base financing rate based on the financial status and providing a predetermined base financing rate upon the user not having a credit score from any of the credit rating agencies. The one or more modules further includes a credit risk agency module configured to receive a selection of at least one credit rating agency from a list of the credit rating agencies displayed on a graphical user interface of a user device, a credit score associated with the selected credit rating agency, and a financing status of the user via the graphical user interface from the user.

The one or more modules includes a risk reduction and incentive module configured to generate and display a list of risk metrics to the user. The list of risk metrics is generated by filtering known risk metrics from a predetermined list of risk metrics and to prompt the user to select at least one risk metrics from the generated list of risk metrics, to calculate a risk reduction rate based on the selected risk metrics, upon the risk metrics being selected by the user, and to calculate a reduced financing rate to be offered to the user. The one or more modules further includes an infographic module configured to generate the cost of financing to the user and the financial infographic associated with a loan of the user or investment to an investee on the financing/investment platform and display the financial infographic to the user via the graphical user interface, where the financial infographic comprises at least the financing status of the user and the reduced financing rate. The one or more modules further includes a financing repayment calculation module configured to initiate a repayment calculation process based on the reduced financing rate, prompt the applicant to provide desired financing amount and duration via the applicant device, and calculate the repayment amount for the provided duration based on the provided financing amount, and the reduced financing rate, upon the information being collected.

In an embodiment, the one or more modules further includes a user module configured to access and manage one or more applicant or lender profiles and/or user information associated with the applicants or the lenders. The user is a one of: a borrower and an investee

In yet another aspect, there is provided one or more non-transitory computer readable storage mediums storing one or more sequences of instructions, which when executed by one or more processors, causes a method of generating a cost of financing to a user and a financial infographic of the user through a financing/investment platform. The method includes receiving a selection of at least one credit rating agency from a list of the credit rating agencies displayed on a graphical user interface of a user device, a credit score associated with the selected credit rating agency, and a financing status of the user, via the graphical user interface, from the user, by a credit risk agency module associated with the financing/investment platform. The method further includes calculating a base financing rate for loan or investment, by a financing rate module, based on at least one of: the credit score received from the user and financing status of the user. The method furthermore includes receiving a selection of risk metrics from the user via the graphical user interface and calculating, a risk reduction incentive rate based on the received selection of risk metrics by the risk reduction and incentive module. The method furthermore includes determining, by the financing rate module, a reduced financing rate by deducting the risk reduction incentive rate from the at least one of: the base financing rate or a predetermined base financing rate. The method furthermore includes generating, by an infographic module, the cost of financing to the user and the financial infographic associated with a loan of the user or investment to an investee on the financing/investment platform where the loan and/or investment can be electronically funded by a plurality of lenders or investors. The financial infographic comprises at least the financing status of the applicant and the reduced financing rate and displaying the financial infographic to the user via the graphical user interface.

In an embodiment, receiving a selection includes displaying a list of the credit rating agencies on the graphical user interface, by a credit risk agency module, prompting the user, by the credit risk agency module to select at least one credit rating agency from a list of credit rating agencies displayed to the user on the graphical user interface, and prompting the user, by the credit risk agency module, to provide the credit score based on the selected credit rating agency. The user is a one of: a borrower and an investee.

In an embodiment, receiving the selection of risk metrics from the user includes generating a list of risk metrics and displaying the list of risk metrics to the user on the graphical user interface by the risk reduction and incentive module, and prompting the user to select one or more risk metrics from the generated list of risk metrics.

### BRIEF DESCRIPTION OF DRAWINGS

These and other features, aspects, and advantages of the present invention will become better understood, when the following detailed description is read with reference to the accompanying drawings in which like characters represent like parts throughout the drawings, wherein:

FIG. 1 is a schematic diagram illustrating a general architecture of a system for generating a financial infographic of a user through a financing/investment platform, in accordance with an embodiment;

FIG. 2 is a block diagram illustrating a method for generating a financial infographic of a user through a financing/investment platform, in accordance with an embodiment;

FIG. 3 is schematic diagram illustrating an exemplary list of credit rating agency, in accordance with an embodiment;

FIG. 4 is a schematic diagram illustrating an exemplary list of results of the different credit rating agencies associated with their respective base financing rates, in accordance with an exemplary scenario;

FIG. 5 is a schematic diagram illustrating an exemplary list of risk metrics, in accordance with an exemplary scenario; and

FIG. 6 is a schematic diagram illustrating an exemplary of an infographic generated by the system, in accordance with an exemplary scenario.

### DETAILED DESCRIPTION OF PREFERRED EMBODIMENTS

It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, that execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions/acts specified in the flowchart and/or block diagram block or blocks.

The term “applicant/user” used in this document can be any individual or entity who is looking for a loan, equity funding or a hybrid of debt equity funding and any other form of investments. The user can also be known as a borrower or investee.

The term “lender” used in this document can be any individual, institutional investor or financial institution such as banks or private organization who lends the loan or fund to the applicant or invests in the applicant's business. The lender can also be an investor.

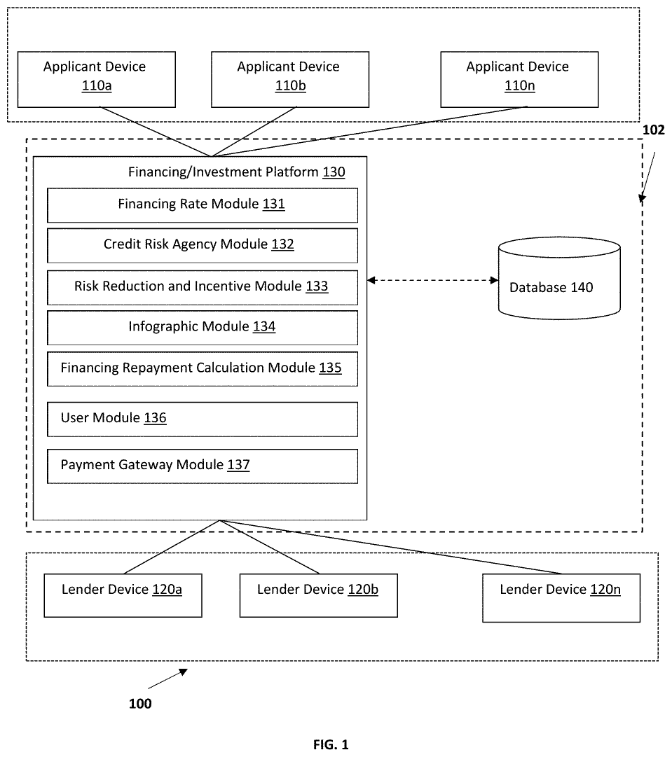

FIG. 1 depicts a schematic diagram illustrating a general architecture of a system 100 and method for generating a cost of financing to a user (e.g., borrower or investee) and for generating a financial infographic of a user through a financing/investment platform 130, in accordance with an embodiment. The system 100 includes one or more applicant devices 110a-110n and one or more lender devices 120a-120n, communicatively associated with a financing system 102. The financing system 102 includes the financing/investment platform 130 communicatively associated with a database 140. Examples of the financing system 102 may include but not limited to a digital banking system, a peer-to-peer lending, financing and/or crowd funding system, online factoring platform, online leasing platform, online equity crowd funding platform and other online money lending/investment platforms. Although the financing/investment platform 130 is described to be an online platform, it should also be noted that it can also be catered for the offline equivalents of abovementioned funding/financing/investment platforms.

The applicant devices 110a-n or the lender devices 120a-n are personal devices owned respectively by the applicants (such as for example, loan applicants, borrowers, investees, and the like) and the lenders (for example, investors). The applicant devices 110a-n and/or the lender devices 120a-n may correspond to any computing devices which are capable of accessing the financing/investment platform 130 via a communication network. The applicant devices 110a-n and/or the lender devices 120a-n can be in the form of portable media players, cellular telephones, pocket-sized personal computers, personal digital assistants (“PDAs”), desktop computers, laptop computers, tablet computers, and the like. The applicant devices 110a-n and/or the lender devices 120a-n may also include control circuitry, storage, memory, communications circuitry, input and/or output interfaces as well as any of the additional features. In addition to that, the applicant devices 110a-n and/or the lender devices 120a-n can be installed with a browser application to access the financing/investment platform 130 through a communication network. The communication network can be a wireless network connection established via a wireless protocol cloud such as Long-Term Evolution (LTE) cloud, Code Division Multiple Access (CDMA) and its derivatives, Enhanced Data Rates for GSM Evolution (EDGE), 3G protocol, High Speed Packet Access (HSPA), 4G protocol, 5G protocol and the like, in accordance to the advancement of wireless technology with time. The communication network can also be a wired network in which the communication is established through a local network port.

Alternatively, the applicant devices 110a-n and/or the lender devices 120a-n can also be installed with an application which is dedicated for carrying out the operations of the financing/investment platform 130. Login credentials may be provided by the financing/investment platform 130 via the applicant devices 110a-n and/or the lender devices 120a-n by the applicants or lenders. The applicant devices 110a-n and/or the lender devices 120a-n can provide quick access to the login credentials via biometric verification so that the applicants or the lenders can login to their respective account on the financing/investment platform in a fast and secured manner. In an embodiment, the financing/investment platform 130 can include an executable application installed in for example, an applicant device.

The financing/investment platform 130 is preferably operated by a centralized cloud-based server (not shown) that is accessible by the applicants and the lenders via their respective devices 110a-n, 120a-n. The cloud-based server may comprise one or more heavy duty computers and any known devices or group of devices to provide sufficient capacity for storing data. The cloud-based server can be in communication with the database 140 that pre-stored with a plurality of computer instructions for carrying out different operations of the financing/investment platform 130. The financing/investment platform 130 is preferably an online peer-to-peer lending/funding/banking/financing/leasing/factoring platform that mainly provides a peer-to-peer lending, funding service, investments or financing & banking services. Such services may include matching lenders money or credits to one or more applicant's loans and the loans are repaid over a defined term. As such, the lenders earn a return via a financing rate payable on the agreed term. Preferably, the financing/investment platform 130 comprises a financing rate module 131, a credit risk agency module 132, a risk reduction and incentive module 133, an infographic module 134, and a financing repayment calculation module 135. The financing/investment platform 130 is an online platform in communication with the database 140 pre-stored with the data related to the financing.

Preferably, the financing rate module 131 is configured to prompt the user/applicant to submit a loan or investment application to the financing/investment platform 130 with details related to their financing status via the applicant device 110. The applicant device 110 may display a virtual loan application form and prompt the user/applicant to provide necessary details before submission of the loan application to the financing/investment platform 130. Preferably, the financing status may include, but is not limited to, personal banking details, occupation, owned property, business details, credit risk ratings from credit risk agencies and etc. The financing rate module 131 is configured to receive a loan or investment application along with at least: a financing status and a credit score, of a user/applicant and perform at least one of: computing a base financing rate based on the financial status and providing a predetermined base financing rate upon the user not having a credit score from any of the credit rating agencies. Upon collection of the information from the user/applicant, the financing rate module 131 subsequently computes a base financing rate based on the financial status provided in the loan or investment application.

Alternatively, in another embodiment, the financing rate module 131 is configured to provide a predetermined base financing rate in case of the applicant does not have any credit score from any of the credit rating agencies. For example, in certain countries, there are maximum allowable loan interest rate such as 18% per annum for uncollateralized loans which can be used as the base financing rate.

Preferably, the credit risk agency module 132 is configured to retrieve data related to a list of the credit rating agencies from the database 140 and display to the user/applicant via the applicant device 110n. The list of credit rating agency may include, but is not limited to, Fair Isaac Corporation's credit scoring system (FICO), Vantage Score, and the like. Further, the credit risk agency module 132 prompts the applicant to select at least one credit rating agency from the displayed list. The credit risk agency module 132 is further configured to receive a selection of at least one credit rating agency from a list of the credit rating agencies displayed on the graphical user interface of the applicant device 110n, a credit score associated with the selected credit rating agency, and a financing status of the user via the graphical user interface from the user.

Preferably, the risk reduction and incentive module 133 is configured to generate and display a list of risk metrics to the applicant. It is noted that the terms “user” and “applicant” are used interchangeably throughout the description. Preferably, the list of risk metrics is generated by filtering known risk metrics from a predetermined list of risk metrics. Further, the risk reduction and incentive module 133 can prompt the applicant or a user to select at least one risk metric from the generated list. The user may be an administrator or a financing specialist that assists the applicant to complete the risk metrics' selection. Once the risk metrics are selected by the applicant, the risk reduction and incentive module 133 then calculates a risk reduction incentive rate based on the selected risk metrics. In an example scenario, different types of risk reduction would enjoy different levels of incentives to the borrowers. For example, for loans or investment notes that are insured against bad debt or delayed payment would enjoy a 2% per annum (p.a.) reduction in interest rate, if the loan is factored against invoices which the buyer is government-linked companies and/or the buyer has more than 50 million in cash or net worth of more than 10 million then the risk reduction incentive is another 2% p.a. reduction in interest rate, when the loan or investment note is guaranteed by the key director the risk reduction incentive is 1.50% p.a., or if the invoice is validated by the finance department of the buyer the risk reduction incentive would be 0.50% p.a. Therefore, if the base interest rate is 16% p.a. and the sum total risk reduction incentive is say 5% p.a., then the net interest rate chargeable to the borrower or investee would be 11% p.a. The risk reduction incentive rate is transmitted to the financing rate module 131 for the calculation of a reduced financing rate to be offered to the applicant.

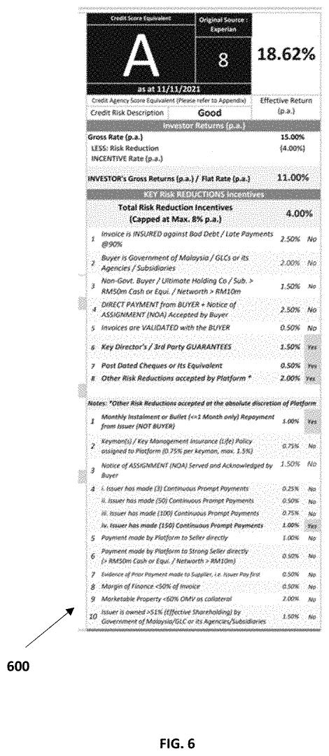

Preferably, the infographic module 134 is configured to generate a financial infographic associated to the loan of the applicant or investment to the applicant. By way of example, such financial infographic may include details relating to the financing status of the applicant, the selected list of risk metrics, applicant's credit score, and the reduced financing rate as shown further in FIG. 6.

Preferably, the financing repayment calculation module 135 is configured to initiate a repayment calculation process based on the reduced financing rate. The financing repayment calculation module 135 may prompt the applicant to provide desired financing amount and duration via the applicant device 110. Once the information is collected, the financing repayment calculation module 135 then calculates the repayment amount for the provided duration based on the provided financing amount, and the reduced financing rate.

Alternatively, the financing/investment platform 130 may further include a graphic user interface module (not shown), a user module 136, and a payment gateway module 137. The main function of the graphical user interface module is to provide a graphical user interface (GUI) that allows the applicants and/or the lenders to interact with the financing/investment platform 130. The interaction may include but not limited to receive input from, and display output to the users. The GUI may be integrated with a plurality of buttons, icons, or widgets and being arranged in a manner where the users can easily access to the operations provided by the financing/investment platform 130. Each of the buttons, icons, or widgets can be linked to their designated module for commencing their designated operations. In addition to that, the GUI can be interchangeable between a mobile-based interface and a web-based interface depending on whether the applicants and/or the lenders are using the browser application or the dedicated application on the applicant devices 110 or the lender device 120 to access the financing/investment platform 130.

The user module 136 is preferably configured to access and manage one or more applicant or lender profiles and/or user information associated with the applicants or the lenders. The profiles and user information of the applicants or the lenders may include information indicating user credentials for authenticating the particular user. The user module 136 also handles all types of operations which relate to the applicants or the lenders such as the registration of new applicant or lender account, log-in of the applicant or lender account, and the assignment of the applicant and lender accounts with their respective level of accessibilities to the operations of the financing/investment platform 130. The user module 136 also can also be linked to an advertisement service to change the current displayed advertisement to one which possibly suits the applicants or lenders upon logged-in.

In an embodiment, the payment gateway module 137 is configured to communicate with a plurality of third-party financial entities to provide multiple choices of payment methods for the users to select. The third-party financial entities may include, but not limited to, PayPal, Braintree, iPay88, eGHL, Alipay, MCash, MOLPay, UnionPay, FPX online banking, VISA and MASTER. The payment gateway module will display to the applicants or lenders with a list of available payment methods and subsequently direct the applicants or lenders to a payment process of the selected method for the completion of the payment. Once the payment is successfully made, the payment gateway module shall receive a payment confirmation from the respective third-party financial entity to proceed with crediting an equivalent amount of credit to the respective applicants or lenders account.

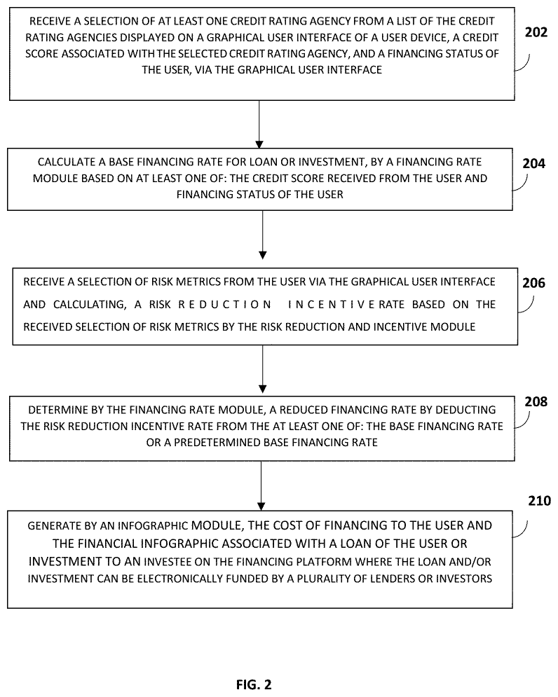

FIG. 2 depicts a flow diagram illustrating the steps involved in a method of generating a cost of financing to a user (e.g., borrower or investee) and for generating a financial infographic of a user through a financing/investment platform 130. At step 202, a selection of at least one credit rating agency from a list of the credit rating agencies displayed on a graphical user interface of a user device, a credit score associated with the selected credit rating agency, and a financing status of the user, via the graphical user interface, is received by a credit risk agency module 132 associated with the financing/investment platform 130 from the user. At step 204, a base financing rate for loan or investment, is calculated by a financing rate module 131, based on at least one of: the credit score received from the user and financing status of the user. At step 206, a selection of risk metrics is received from the user via the graphical user interface and calculating, a risk reduction incentive rate based on the received selection of risk metrics by the risk reduction and incentive module 133. In an embodiment, receiving the selection of risk metrics includes displaying a list of the credit rating agencies on the graphical user interface, by a credit risk agency module (132); prompting the user, by the credit risk agency module (132) to select at least one credit rating agency from a list of credit rating agencies displayed to the user on the graphical user interface; and prompting the user, by the credit risk agency module (132), to provide the credit score based on the selected credit rating agency. In an embodiment, a list of risk metrics is generated and displaying the list of risk metrics to the user on the graphical user interface by the risk reduction and incentive module (133). The user is prompted to select one or more risk metrics from the generated list of risk metrics.

At step 208, the financing rate module 131, determines a reduced financing rate by deducting the risk reduction incentive rate from the at least one of: the base financing rate or a predetermined base financing rate. At step 210, an infographic module 134, generates the cost of financing to the user (e.g., borrower or investee) and a financial infographic associated with a loan of the user or investment to an investee on the financing/investment platform 130 where the loan and/or investment can be electronically funded by a plurality of lenders or investors, wherein the financial infographic comprises at least the financing status of the applicant and the reduced financing rate and displaying the financial infographic to the user via the graphical user interface.

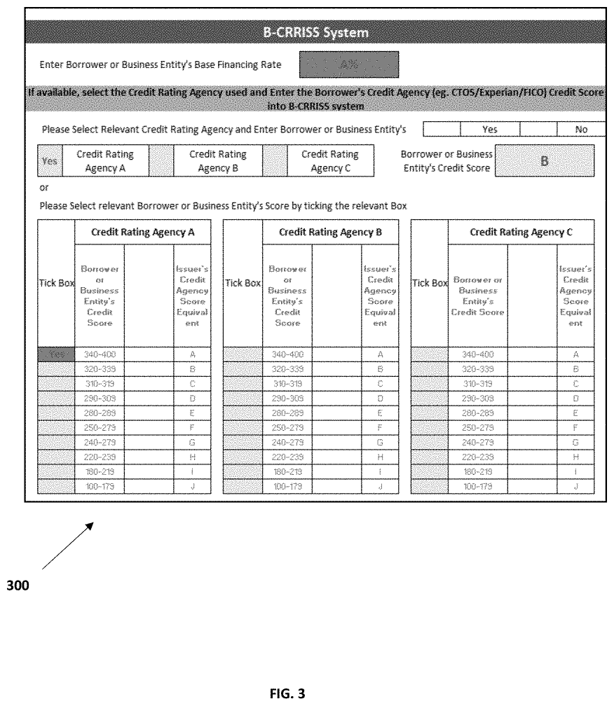

FIG. 3 depicts an example 300 of the displayed list of credit rating agency, in accordance with an exemplary scenario. In an embodiment, upon receiving the selection from the applicant, the credit risk agency module 132 then establishes a communication link to a corresponding credit risk agency server for retrieving a credit rating information relating to the applicant. Alternatively, the credit risk agency module 132 can prompt the applicant to provide the credit rating information. Preferably, the applicant's credit score is calculated based on following parameters: payment history, amounts owed, length of credit history, new credit, and credit mix. The credit score for a small business is based on information in its credit report which includes: company information (including number of employees, sales, ownership, and subsidiaries), historical business data, business registration details, government activity summary, business operational data, industry classification and data, public filings (liens, judgments, and UCC filings), payment history and collections, and number of accounts reporting and details. In general, the higher the credit score, the lower the base financing rate.

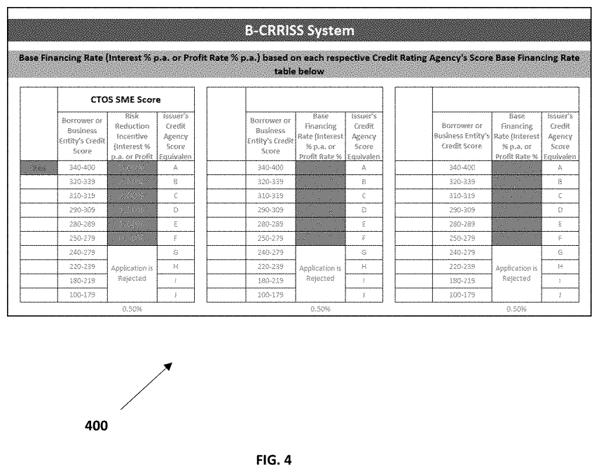

FIG. 4 is a schematic diagram illustrating an exemplary list of results of the different credit rating agencies associated with their respective base financing rates, in accordance with an exemplary scenario. Preferably, the credit risk agency module 132 is configured to retrieve data related to a list of the credit rating agencies from the database 140 and display to the user/applicant via the applicant device 110n. The list of credit rating agency may include, but is not limited to Fair Isaac Corporation's credit scoring system (FICO), VantageScore, CTOS and the like. In an embodiment, the credit risk agency module 132 prompts the applicant to select at least one credit rating agency from the displayed list. In an embodiment, the credit risk agency module receives a selection of at least one credit rating agency from a list of the credit rating agencies displayed on the graphical user interface of the applicant device 110n, a credit score associated with the selected credit rating agency, and a financing status of the user via the graphical user interface from the user.

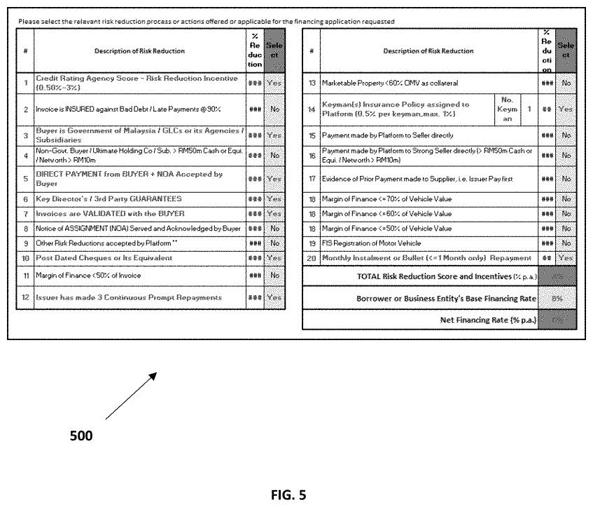

FIG. 5 depicts an example 500 of the risk metrics, in accordance with an exemplary scenario. Further, the risk reduction and incentive module 133 can prompt the applicant or a user to select at least one risk metric from the generated list. The user may be an administrator or a financing specialist that assists the applicant to complete the risk metrics' selection. Once the risk metrics are selected by the applicant, the risk reduction and incentive module 133 then calculates a risk reduction rate based on the selected risk metrics. Lastly, the risk reduction rate is transmitted to the financing rate module 131 for the calculation of a reduced financing rate to be offered to the applicant.

FIG. 6 is a schematic diagram illustrating an example of a calculated cost of financing to a user (e.g., borrower or investee) and a financial infographic 600 generated by the system 100 of the invention, in accordance with an exemplary scenario. The financial infographic 600 includes at least the financing status of the user and the reduced financing rate. The infographic module 134 generates a financial infographic associated to the loan of the applicant or investment to the applicant. By way of example, such financial infographic may include details relating to the financing status of the applicant, the selected list of risk metrics, applicant's credit score, and the reduced financing rate as shown in FIG. 6.

Various embodiments of the present technology provide an estimate of a borrower's default probability. However, the present technology does not explicitly factor in current economic conditions and reflect any changes in real time. In other words, the credit score models are based on historical data and they cannot reflect any changes in real time. The invention highlights to the lenders or the investors the various risk reduction that a borrower or an investee has offered or committed such as provision of directors and 3^{rd} party corporate guarantees to the loan facility or investment, provision of post-dated cheques, provision of marketable security as collateral, allowing direct payment of financing to their suppliers or sellers and many others. In return for lowering the borrowers or investees credit and repayment risks, they get rewarded with lower financial costs. As for the lenders or investors, they get to choose the various loans or investments presented to them based on the overall risk profile of the borrowers and investees and its corresponding financial returns after deducting the various risk reduction incentives that is able to be presented using this technology. This invention takes into consideration of current economic conditions and reflect changes in real time and factors these to derive a cost of financing that is real-time, risk-based adjusted and fairer to both the borrower or investee and the lender or investor.

The embodiments of the system of the present technology herein can take the form of, an entirely hardware embodiment, an entirely software embodiment or an embodiment including both hardware and software elements. The embodiments that are implemented in software include but are not limited to, firmware, resident software, microcode, etc. Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, Subscriber Identity Module (SIM) card, and cache memories which provide temporary storage of at least some program code in order to reduce the number of times code must be retrieved from bulk storage during execution. Input/output (I/O) devices (including but not limited to keyboards, displays, pointing devices, remote controls, camera, microphone, temperature sensor, accelerometer, gyroscope, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation.

The present disclosure includes as contained in the appended claims, as well as that of the foregoing description. Although this invention has been described in its preferred form with a degree of particularity, it is understood that the present disclosure of the preferred form has been made only by way of example and that numerous changes in the details of construction and the combination and arrangements of parts may be resorted to without departing from the scope of the invention.

1. A processor-implemented method of generating a cost of financing to a user and a financial infographic of the user through a financing/investment platform, the method comprising use of a processor to perform the steps of:
receiving a selection of at least one credit rating agency from a list of the credit rating agencies displayed on a graphical user interface of an applicant device, a credit score associated with the selected credit rating agency, and a financing status of the user, via the graphical user interface, from the user, by a credit risk agency element associated with the financing/investment platform;
calculating a base financing rate for loan or investment, by a financing rate element, based on at least one of:
the credit score received from the user; and
financing status of the user;
receiving a selection of risk metrics from the user via the graphical user interface and calculating, a risk reduction incentive rate based on the received selection of risk metrics by the risk reduction and incentive element;
determining, by the financing rate element, a reduced financing rate by deducting the risk reduction incentive rate from the at least one of:
the base financing rate; and
a predetermined base financing rate;
generating, by an infographic element, the cost of financing the user and the financial infographic associated with a loan of the user or investment to an investee on the financing/investment platform wherein:
the loan or investment can be electronically funded by a plurality of lenders or investors; and
the financial infographic comprises at least the financing status of the applicant and the reduced financing rate; and
displaying the financial infographic to the user via the graphical user interface.

2. The processor-implemented method of claim 1, wherein receiving a selection comprises:
displaying a list of the credit rating agencies on the graphical user interface, by a credit risk agency element;
prompting the user, by the credit risk agency element to select at least one credit rating agency from a list of credit rating agencies displayed to the user on the graphical user interface; and
prompting the user, by the credit risk agency element, to provide the credit score based on the selected credit rating agency.

3. The processor-implemented method of claim 1, wherein:
the user is a one of a borrower and an investee and
receiving the selection of risk metrics from the user comprises:
generating a list of risk metrics and displaying the list of risk metrics to the user on the graphical user interface by the risk reduction and incentive element; and
prompting the user to select one or more risk metrics from the generated list of risk metrics.

4. A system for generating a cost of financing to a user and a financial infographic of the user through a financing/investment platform, the financing/investment platform operated by a centralized cloud-based server and operatively coupled to a database (140), the financing/investment platform comprising:
a memory that stores an information associated with financing/investment platform and one or more executable elements;
a processor that executes the one or more executable elements using the information associated with the financing/investment platform, the one or more executable elements comprising:
a financing rate element that, when executed;
receives a loan or investment application along with at least:
a financing status; and
a credit score, of a user; and
performs at least one of:
computing a base financing rate based on the financial status; and
providing a predetermined base financing rate upon the user not having a credit score from any of the credit rating agencies;
a credit risk agency element that, when executed, receives:
a selection of at least one credit rating agency from a list of the credit rating agencies displayed on a graphical user interface of an applicant device;
a credit score associated with the selected credit rating agency; and
a financing status of the user via the graphical user interface from the user;
a risk reduction and incentive element that, when executed:
generates and displays a list of risk metrics to the user, wherein the list of risk metrics is generated by filtering known risk metrics from a predetermined list of risk metrics and to prompt the user to select at least one risk metrics from the generated list of risk metrics;
calculates a risk reduction incentive rate based on the selected risk metrics, upon the risk metrics being selected by the user; and
calculates a reduced financing rate to be offered to the user based on the risk reduction incentive rate; and
an infographic element that, when executed:
generates the cost of financing to the user and the financial infographic associated with a loan of the user or investment to an investee on the financing/investment platform; and
displays the financial infographic to the user via the graphical user interface, wherein the financial infographic comprises at least:
the financing status of the user;
the risk reduction incentive rate; and
the reduced financing rate.

5. The system of claim 4, wherein the one or more elements further comprises a financing repayment calculation element that, when executed:
initiates a repayment calculation process based on the reduced financing rate;
prompts the applicant to provide desired financing amount and duration via the applicant device; and
calculates the repayment amount for the provided duration based on the provided financing amount, and the reduced financing rate, upon the information being collected.

6. The system of claim 5, wherein:
the user is a one of:
a borrower; and
an investee; and
the one or more elements further comprises a user element that, when executed, accesses and manages one or more applicant or lender profiles or user information associated with the applicants or the lenders.

7. One or more non-transitory computer readable storage media storing one or more sequences of instructions, which when executed by one or more processors, cause to be performed a method of generating a cost of financing a user and a financial infographic of the user through a financing/investment platform, said method comprising the steps of:
receiving a selection of at least one credit rating agency from a list of the credit rating agencies displayed on a graphical user interface of an applicant device, a credit score associated with the selected credit rating agency, and a financing status of the user via the graphical user interface from the user, by a credit risk agency element associated with the financing/investment platform;
calculating a base financing rate for loan or investment, by a financing rate element, based on at least one of:
the credit score received from the user; and
financing status of the user;
receiving a selection of risk metrics from the user via the graphical user interface and calculating, a risk reduction incentive rate based on the received selection of risk metrics by the risk reduction and incentive element;
determining, by the financing rate element, a reduced financing rate by deducting the risk reduction incentive rate from the at least one of:
the base financing rate; and
a predetermined base financing rate;
generating, by an infographic element, the cost of financing to the user and the financial infographic associated with a loan of the user or investment to an investee on the financing/investment platform wherein:
the loan or investment can be electronically funded by a plurality of lenders or investors; and
the financial infographic comprises at least the financing status of the applicant, the risk reduction incentive rate, and the reduced financing rate; and displaying the financial infographic to the user via the graphical user interface.

8. The one or more non-transitory computer readable storage media of claim 7, wherein receiving a selection comprises:
displaying a list of the credit rating agencies on the graphical user interface, by a credit risk agency element;
prompting the user, by the credit risk agency element to select at least one credit rating agency from a list of credit rating agencies displayed to the user on the graphical user interface; and
prompting the user, by the credit risk agency element, to provide the credit score based on the selected credit rating agency.

9. The one or more non-transitory computer readable storage media of claim 8, wherein receiving a selection comprises:
displaying a virtual loan application form and prompting the user to provide necessary details before submission of the loan application to the financing/investment platform.

10. The one or more non-transitory computer readable storage media of claim 8, wherein:
the user is a one of:
a borrower; and
an investee; and
receiving the selection of risk metrics from the user comprises:
generating a list of risk metrics and displaying the list of risk metrics to the user on the graphical user interface by the risk reduction and incentive element; and
prompting the user to select one or more risk metrics from the generated list of risk metrics.
